(19) United States
(12) Patent Application Publication
(10) Pub. No.: US 2006/0237372 A1
(43) Pub. Date: Oct. 26, 2006

(54) Separation of drilling mud emulsions

(75) Inventors: Jan Arciszewski, Sherwood Park (CA); Jonathon Dueck, Red Deer (CA)

Correspondence Address: WEGMAN, HESSLER & VANDERBURG, 6055 ROCKSIDE WOODS BOULEVARD, SUITE 200, CLEVELAND, OH, 44131, US

(73) Assignee: GE Betz, Inc., Trevose, PA (US)

(21) Appl. No.: 11/113,168

(22) Filed: Apr. 22, 2005

(51) Int. Cl. B01D 17/04; C09K 8/60

(52) U.S. Cl. 210/708; 175/66

(57) ABSTRACT

Methods and compositions for improved separation of inverted drilling mud emulsions into their component phases. The emulsion is mixed with a treatment comprising a cationic acrylamide/quaternary ammonium copolymer (I) and a cationic coagulant (II) comprising a copolymer of a tannin, and cationic monomer.

### FIELD OF INVENTION

The present invention pertains to methods and compositions for separating drilling mud emulsions into their constituent phases.

### BACKGROUND OF THE INVENTION

Inverted emulsions (W/O) are those in which a non-oleaginous fluid is present in the dispersed phase and an oleaginous fluid is present as the continuous phase. These emulsions are commonly employed in drilling processes such as for the development of oil, or gas, or sometimes in geothermal and other drilling processes. These inverted emulsions are commonly used to provide stability to the drilled hole, to lubricate the hole, and form a thin filter cake.

Oil based drilling fluids are commonly used in the form of inverted emulsion muds consisting of three phases: an oleaginous phase, a non-oleaginous phase, and a finely divided phase. These fluids also contain a variety of emulsifiers, weighting additives, fluid retention aids, viscosity modifiers, etc., to stabilize the system as a whole and for establishing desired performance properties.

During drilling operations, the muds may become contaminated with debris that is carried by the drilling bits and with liquids such as water and brines that enter the drilling hole from above or by leaching into the hole through subterranean locations. Additionally, the mud that is employed in these emulsions includes clays that are used primarily as viscosity builders. These clays can separate from each other during use and absorb oil that exists in the emulsion. As a result, the emulsions can change during drilling operations.

These emulsions become difficult to break or resolve as they change in composition during use. These difficult to break emulsions are often referred to as “slop”. This “slop” cannot be discharged directly due to environmental concerns so that it has therefore become important to efficiently resolve or separate the emulsion constituents into an oleaginous (oil) phase and a combined mud/non-oleaginous (i.e.) water phase. The oil phase may be used as a process fluid for refinery or other processes or recycled for down hole usage. The mud/water phase may be sent to further separation processes to separate the water for discharge or other use and the mud for possible recycling into down hole operations.

Additionally, in some cases, the drilling mud actually seeps out of formation into the crude oil that is being extracted to form an undesirable drilling mud emulsion containing crude oil as a component.

### DETAILED DESCRIPTION

Accordingly, one aspect of the invention pertains to an improved separation technique and treatment for separating the components of crude oil containing drilling mud emulsions while another aspect of the invention pertains to the resolution of the inverted W/O drilling emulsions themselves as they are recovered from down hole operations so that the emulsion components can be recycled for subsequent use or to be more safely disposed of.

We have found that drilling mud/crude oil emulsions can be separated into component phases of water, mud, and oil by addition, to the emulsion, of a combination of cationically charged materials. More specifically, a cationic flocculant and cationic coagulant are both added to the emulsion in order to improve separation of the emulsion into its constituent parts, i.e., oil, water, and solids. Preferably, the separation is carried out in a centrifugal separator such as a centrifuge or the like with the emulsion and additives admitted thereto and mixed therein. Preliminary results indicate improvement in separation of the oil phase from the water phase and mud phase in a crude oil/drilling mud emulsion that is subjected to a centrifugal separation system.

As to the cationic flocculent (I) that is to be used conjointly with the cationic coagulant (II), these include the cationic acrylamide/quaternary ammonium salt copolymers. More specifically, these can be represented by the following Formula I: 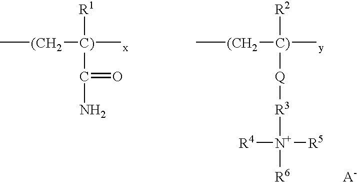
In Formula I, the molar ratio of repeat units x:y may vary from 95:5 to 5:95 with the molar ratio (x):(y) of 60:40 being presently preferred. R¹ and R² may be the same or different and are chosen from H and CH₃. Q is —C(O)O—, —OC(O)—, or —C(O)NH—, R³ is branched or linear (C₁-C₄) alkylene; R⁴, R⁵, and R⁶ are independently chosen from H, C₁-C₄ linear branched alkyl, or an C₅-C₈ aromatic or alkylaromatic group; A is an anion selected from Cl⁻, Br⁻, HSO4, or MeOSO₃⁻.

Exemplary repeat units (y) are as follows:
1. (AETAC)—2-acryloxyethyltrimethyl ammonium chloride; also referred to as dimethylaminoethylacrylate methyl chloride; in terms of Formula I above R¹=H; R²=H; Q is —C(O)O—, R³=Et; R⁴, R⁵, and R⁶ are all Me, and A is Cl—.
2. (MATAC)—3-(meth) acrylamidopropyltrimethyl ammonium chloride; in terms of Formula I above R¹=H; R²=CH₃; Q is —C(O)NH—; R³=Pr; R⁴, R⁵, and R⁶ are all Me, and A is Cl⁻.
3. (METAC)—2-methacryloxyethyltrimethyl ammonium chloride; in terms of Formula I above R¹=H; R²=CH₃; Q is —C(O)O—; R³ is Et and R⁴, R⁵, and R⁶ are all Me, and A is Cl^{˜}.

The presently preferred cationic flocculant (I) copolymer is a 60:40 mole percent acrylamide/AETAC copolymer. The copolymer may be cross-linked as explained hereinafter. The degree of cross-linking is relatively minor and can amount from about 1×10⁻⁴% to about 5×10⁻³% based on 100 molar percent of the repeat units (x) and (y) present. Also, non-cross-linked copolymers (1) may be used.

General techniques for preparing the cationic flocculant (I) copolymers are reported in U.S. Pat. Nos. 3,284,393 and 5,006,596. The disclosures of these patents are incorporated by reference herein. As to the cross-linking techniques that may be employed, these are set forth in allowed U.S. application Ser. No. 10/816,758 to be issued as U.S. Pat. No. 6,887,935 on May 3, 2005. The disclosure of this allowed application is also incorporated by reference herein.

The copolymers may be prepared by a water-in-oil emulsion technique. Such processes have been disclosed in U.S. Pat. Nos. 3,284,393 and 5,006,596 herein incorporated by reference. The technique is generally as follows:

Preparation of an aqueous phase, typically ranging from about 50% to about 90% by weight of the total emulsion, which aqueous phase is comprised of water, monomers as described above, chelating agents and initiator(s), if the particular initiator(s) chosen are water-soluble. Ethylenediamine tetraacetic acid or diethylenetriamine pentaacetic acid and their salts are suitable, but not limiting, chelating agents. The water-soluble initiator may be selected from peroxides, persulfates, and bromates. Sulfites, bisulfites, sulfur dioxide, and other reducing agents used with oxidizing initiators to form an initiating redox pair may also be used. If a reducing agent or a water-soluble azo-type, thermal initiator such as 2,2′-azobis-(2-amidinopropane) dihydrochloride, is used, it is added as described below. The total amount of monomers will range from about 30% to about 80%, by weight, based on the total weight of the aqueous phase.

Preparation of an oil phase, ranging from about 10% to about 50% by weight of the total emulsion, which oil phase is comprised of a liquid organic hydrocarbon and water-in-oil emulsifying agents. A preferred group of hydrocarbon liquids include aliphatic compounds. Oils commonly used for this purpose are the hydrotreated petroleum distillates, such as the commercially available materials sold under the trademarks of Vista LPA-210, Shellsol D100S, and Exxsol D100S. The oil phase may optionally contain the initiator(s), if the particular initiator(s) chosen are oil-soluble. Typical oil-soluble, thermal initiators would be 2,2′-azo-bis (isobutyronitrile), 2,2′-azobis (2,4-dimethylvaleronitrile) and benzoyl peroxide, and the like. It is well known to those skilled in the art that the initiator(s) can be chosen to be either water- or oil-soluble depending on the particular needs of the system.

The water-in-oil emulsifying agent is usually a low HLB surfactant. Typical emulsifiers are mono and diglycerides, sorbitan fatty acid esters and lower N,N-dialkanol substituted fatty amides, and the like, and are described in U.S. Pat. Re. No. 28,576.

A mixture of emulsifying surfactants, rather than single emulsifier, may be preferred. The concentration of emulsifier can be from about 3 % to about 30% by weight, based on the total weight of the oil phase. Polymeric surfactants such as modified polyester surfactants (Hypermer, ICI) and maleic anhydride-substituted ethylene copolymers (PA-14 or 18, Chevron) may also be added to improve the mechanical stability and increase the solids content of the emulsion.

After the aqueous phase and oil phase have been prepared separately, the aqueous phase is then homogenized into the oil phase. Homogenizers, high shear pumps, or high-speed agitators that are capable of mixing the two phases into a homogeneous water-in-oil emulsion may be used. Any of the techniques to prepare the inverse emulsions well known to those skilled in the art may be used. Typically, the particle size of the resulting emulsion is between 10 μm and 2 μm. After the emulsion is prepared, the system is then sparged with nitrogen to remove all oxygen from the system. The emulsion is under constant agitation or circulation. Polymerization is then initiated by adding a reducing agent from a red-ox pair or by heat to induce the decomposition of a thermal initiator in the emulsion after its addition. The temperature of the reaction medium is maintained at about 20° C. to about 75° C., preferably about 35° C. to about 55° C.

The initiation step may be conducted in the absence of a cross-linking agent or chain transfer agent. ¹³C NMR techniques can be utilized to assess the degree of conversion of the monomers into the copolymer. In one technique, after waiting until about greater than 50% or more of the conversion has occurred, the cross-linking agent is then added continuously to the reaction mixture in the absence of addition of any chain transfer agent. The cross-linking agent may be added continuously after the polymerization reaction has achieved a total monomer conversion of from about 75%-99%, more preferably 80%-95%.

As to the cross-linking agents that may be used, these are well known in the art and function to provide cross-linked polymers in which a branch or branches from one polymer molecule are effectively linked or attached to other polymer molecules. A noteworthy cross-linker is N,N′-methylenebisacrylamide (MBA) but a host of other cross-linking agents such as divinylbenzene, diethylene glycol diacrylate, propylene glycol dimethacrylate, diallylfumarate, propylene glycol dimethacrylate, allylacrylate, diallylfumarate and vinylalkoxy silanes may also be mentioned.

The cross-linking agent may be added in an amount of about 1 ppm to about 5×10⁻⁴ ppm based on the total amount of the reaction mixture. In one embodiment, MBA may be added in an amount of about 1-500 ppm, preferably from about 2 to about 150 ppm, more preferably from about 3 to about 50 ppm and most preferably from about 4 to about 12 ppm based on total monomers.

The molecular weight of the copolymer may vary over a wide range, for example, 10,000-20,000,000. Usually, the copolymers will have molecular weights in excess of 1,000,000. The cationic flocculant copolymer should be water soluble. It is present practice to employ the cationic flocculant copolymer (I) in the form of a water in oil emulsion. The oil phase may comprise hydrotreated isoparaffins and napthenics with a low level of aromatics.

Turning now to the cationic coagulants (II) that are to be conjointly used with the cationic flocculant (I), these may be described as copolymers of a tannin and a cationic monomer as described for instance in U.S. Pat. No. 5,916,991, the disclosure of which is incorporated by reference herein. As is set forth in the '991 patent, tannin, also called tannic acid, occurs in the leaf, branch, bark, and fruit of may plants. As disclosed by A. Pizzi in “Condensed Tannin for Adhesives”, Ind. Eng. Chem. Prod. Res. Dev. 1982, 21 pages 359-369, the natural tannins can be as “hydrolysable” tannin and “condensed” tannin. The composition and structure of tannin will vary with the source and the method of extraction, but the empirical structure is given as C₇₆H₅₂O₄₆ with many OH groups attached to the aromatic rings. The tannin may be a condensed tannin type including but not limited to those derived from Quebrancho, Mimosa and Sumac or a hydrolysable tannin.

The cationic coagulant (II) is a water soluble or water dispersible tannin containing polymer that includes from about 10 to about 80% by weight of tannin, 20 to 90% by weight of cationic monomer, 0 to 30% by weight of nonionic monomer and 0 to 20% by weight of anionic monomer, provided that the resulting tannin containing polymer is water soluble or dispersible and the total weight percent of cationic, nonionic and anionic monomers and tannin adds up to 100%. Preferably, when the cationic monomer and anionic monomer are present together in the tannin containing polymer, the cationic monomer comprises a greater weight percentage than the anionic monomer.

The cationic monomer may be selected from a group containing ethylenically unsaturated quaternary ammonium, phosphonium, or sulfonium ions. Typical cationic monomers are quaternary ammonium salts of dialkylaminoalkyl(meth) acrylamides, dialkylaminoalkyl(meth)acrylates and diallyl dialkyl ammonium chloride.

The preferred cationic monomers are selected from the group including, but are not limited to, methyl chloride quaternary salt of diethylaminoethyl acrylate, dimethyl sulfate salt of diethylaminoethyl acrylate, dimethylaminoethyl acrylate, dimethylaminoethyl methacrylate, diethylaminoethyl methacrylate, dimethylaminopropyl methacrylamide, dimethylaminopropyl acrylamide, diallyldimethyl ammonium chloride and diallyldiethyl ammonium chloride. The most preferred cationic monomer is methyl chloride quaternary salt of diethylaminoethyl acrylate.

The optional anionic monomer may be selected from the group containing ethylenically unsaturated carboxylic acid or sulfonic acid functional groups. These monomers include but are not limited to acrylic acid, methacrylic acid, vinyl acetic acid, itaconic acid, maleic acid, allylacetic acid, styrene sulfonic acid, 2-acrylamido-2-methyl propane sulfonic acid (AMPS®) and 3-allyloxy-2-hydroxypropane sulfonic acids and salts thereof. A noteworthy anionic monomer is acrylic acid.

The optional nonionic monomer may be selected from the group of ethylenically unsaturated nonionic monomers which comprise but are not limited to acrylamide, methacrylamide, N-methylolacrylamide, N,N-dimethylacrylamide; lower alkyl (C₁-C₆) esters including vinyl acetate, methyl acrylate, ethyl acrylate and methyl methacrylate; hydroxylated lower alkyl (C₁-C₆) esters including hydroxylethyl acrylate hydroxypropyl acrylate and hydroxyethyl methacrylate; allyl glycidyl ether; and ethoxylated allyl ethers of polyethylene glycol, polypropylene glycol and propoxylated acrylates. Noteworthy nonionic monomers include allyl glycidyl ether and acrylamide.

The preferred copolymer of tannin and cationic monomer contains 20 to 80 wt % of tannin. More preferably, the copolymer contains from about 30 to 70 wt % tannin and most preferably, from 50 to 70 wt % of tannin in the copolymer, provided the total weight of tannin and cationic monomer (and optional anionic and nonionic monomer) totals 100 weight percent. The particular copolymers that are most preferred include a Mimosa type tannin, and the cationic monomer is methyl chloride quaternary salt of dimethylaminoethyl acrylate.

Preferably, the tannin/cationic monomer is an AETAC modified condensed tannin (AETAC=dimethylamino ethyl acrylate quat) having a molar ratio of tannin:AETAC of about 1 to 4.89.

The cationic flocculant I and cationic coagulant II are usually fed to the inverted drilling mud containing emulsion separately in the following exemplary treatment amounts.

cationic flocculant (I)

| | |
|---|---|
| exemplary | 1-2000 ppm |
| preferred | 25-150 ppm |

cationic coagulant (II)

| | |
|---|---|
| exemplary | 100-3,000 ppm |
| preferred | 250-1,000 ppm |

The artisan will appreciate that the term “oleaginous liquid” as used herein means an oil which is a liquid at 25° C. and immiscible with water. Oleaginous liquids typically include substances such as crude oil, diesel oil, mineral oil, synthetic oil, ester oils, glycerides of fatty acids, aliphatic esters, aliphatic ethers, aliphatic acetals, or other such hydrocarbons and combinations of these fluids.

The amount of oleaginous liquid in the inverted drilling mud emulsion fluid may vary depending upon the particular oleaginous fluid used, the particular non-oleaginous fluid used, and the particular application in which the inverted emulsion fluid is to be employed. However, generally the amount of oleaginous liquid must be sufficient to form a stable emulsion when utilized as the continuous phase. Typically, the amount of oleaginous liquid is at least about 30, preferably at least about 40, more preferably at least about 50 percent by volume of the total fluid.

As used herein, the term “non-oleaginous liquid” means any substance which is a liquid at 25° C. and which is not an oleaginous liquid as defined above. Non-oleaginous liquids are immiscible with oleaginous but capable of forming emulsions therewith. Typical non-oleaginous liquids include aqueous substances such as fresh water, sea water, brine containing inorganic or organic dissolved salts, aqueous solutions containing water-miscible organic compounds and mixtures of these. For example, the non-oleaginous fluid may be a brine solution including inorganic salts such as calcium halide salts, zinc halide salts, alkali metal halide salts, and the like.

The amount of non-oleaginous liquid in the inverted emulsion fluid may vary depending upon the particular non-oleaginous fluid used and the particular application in which the inverted emulsion fluid is to be employed. Typically, the amount of non-oleaginous liquid is at least about 1, preferably at least about 3, more preferably at least about 5 percent by volume of the total fluid. Correspondingly, the amount should not be so great that it cannot be dispersed in the oleaginous phase. Therefore, typically the amount of non-oleaginous liquid is less than about 90, preferably less than about 80, more preferably less than about 50 percent by volume of the total fluid.

Various surfactants and wetting agents conventionally used in inverted emulsion fluids may be incorporated in the fluids of this invention. Such surfactants are, for example, fatty acids, soaps of fatty acids, amido amines, polyamides, polyamines, oleate esters, imidazoline derivatives, oxidized crude tall oil, organic phosphate esters, alkyl aromatic sulfates and sulfonates, as well as, mixtures of the above.

Viscosifying agents, for example, organophillic clays, may optionally be employed in the inverted drilling fluid composition of the present invention. Usually, other viscosifying agents, such as oil soluble polymers, polyamide resins, polycarboxylic acids and fatty acid soaps may also be employed. The amount of viscosifying agent used in the composition will necessarily vary depending upon the end use of the compositions. Usually, such viscosifying agents are employed in an amount which is at least about 0.1, preferably at least about 2, more preferably at least about 5 percent by weight by volume of the total fluid.

The inverted emulsion drilling fluids may optionally contain a weight material. The quantity and nature of the weight material depends upon the desired density and viscosity of the final composition. The preferred weight materials include, but are not limited to, barite, calcite, mullite, gallena, manganese oxides, iron oxides, mixtures of these and the like. The weight material is typically added in order to obtain a drilling fluid density of less than about 24, preferably less than about 21, and most preferably less than about 19.5 pounds per gallon.

Fluid retention agents such as modified lignite, polymers, oxidized asphalt and gilsonite may also be added to the inverted drilling fluids of this invention. Usually, such fluid loss control agent are employed in an amount which is at least about 0.1, preferably at least about 1, more preferably at least about 5 percent by weight to volume of the total fluid.

As used herein, the term “copolymer” shall also encompass ter, quadra, penta, etc., polymers having more than 2 types of monomeric repeat unit moieties. Also, the term emulsion as used herein includes not only true emulsions but mixtures as well.

The following examples are included to demonstrate preferred embodiments of the emulsion breakers of the invention. It should be appreciated by those of skill in the art that the techniques disclosed in the examples which follow represent techniques discovered by the inventors, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

Tests were conducted with centrifugal separation of the inverted drilling mud emulsion samples. The tests were conducted without treatment and with the cationic flocculant (I) and cationic coagulation (II) present, either singly or in combination. The test emulsion was a mixture of crude oil and inverted drilling mud emulsion. The centrifugation, when successful, results in resolution or breaking of the emulsion into an oil phase, a mud phase, and water phase. Results are shown in the following table.

| | | | | | Sample | | | | | |
|---|---|---|---|---|---|---|---|---|---|---|
| | | Polymer | Cat. | | Composition | | | | | |
| Cat. | Time | dosage | Coag | CCII | % | % | % | Mud Composition | | |
| Floc.(I) | Min | ppm | (II) | dosage | Oil | Water | Mud | Oil | Water | Solids |
| 18-Jun-04 | | | | | | | | | | |
| STAGE 1 | Blanks No Chemicals | | | | | | | | | |
| None | 8 | 0 | none | | 90 | | 10 | 68 | 24 | 8 |
| None | 8 | 0 | none | | 75 | | 25 | 68 | 24 | 8 |
| None | 8 | 0 | none | | 50 | | 50 | 68 | 24 | 8 |
| None | 8 | 0 | none | | 25 | | 75 | 68 | 24 | 8 |
| STAGE 2 | Demulsifier at 1000 ppm | | | | | | | | | |
| None | 8 | 0 | A-40 | 1000 | 90 | | 10 | 68 | 24 | 8 |
| | | | | ppm | | | | | | |
| None | 8 | 0 | A-40 | 1000 | 75 | | 25 | 68 | 24 | 8 |
| | | | | ppm | | | | | | |
| None | 8 | 0 | A-40 | 1000 | 50 | | 50 | 68 | 24 | 8 |
| | | | | ppm | | | | | | |
| None | 8 | 0 | A-40 | 1000 | 25 | | 75 | 68 | 24 | 8 |
| | | | | ppm | | | | | | |
| STAGE 3 | Demulsifier at 2000 ppm | | | | | | | | | |
| None | 8 | 0 | A-40 | 2000 | 90 | | 10 | 68 | 24 | 8 |
| | | | | ppm | | | | | | |
| None | 8 | 0 | A-40 | 2000 | 75 | | 25 | 68 | 24 | 8 |
| | | | | ppm | | | | | | |
| None | 8 | 0 | A-40 | 2000 | 50 | | 50 | 68 | 24 | 8 |
| | | | | ppm | | | | | | |
| None | 8 | 0 | A-40 | 2000 | 25 | | 75 | 68 | 24 | 8 |
| | | | | ppm | | | | | | |
| STAGE 4 | Stage 1 - Best of either Stage 2 or 3 with 20% water | | | | | | | | | |
| None | 8 | 0 | none | | 90 | 20 | 10 | 68 | 24 | 8 |
| None | 8 | 0 | none | | 75 | 20 | 25 | 68 | 24 | 8 |
| None | 8 | 0 | none | | 50 | 20 | 50 | 68 | 24 | 8 |
| None | 8 | 0 | none | | 25 | 20 | 75 | 68 | 24 | 8 |
| None | 8 | 0 | A-40 | 1000 | 90 | 20 | 10 | 68 | 24 | 8 |
| | | | | ppm | | | | | | |
| None | 8 | 0 | A-40 | 1000 | 75 | 20 | 25 | 68 | 24 | 8 |
| | | | | ppm | | | | | | |
| None | 8 | 0 | A-40 | 1000 | 50 | 20 | 50 | 68 | 24 | 8 |
| | | | | ppm | | | | | | |
| None | 8 | 0 | A-40 | 1000 | 25 | 20 | 75 | 68 | 24 | 8 |
| | | | | ppm | | | | | | |
| None | 21 | 0 | none | | 90 | 20 | 10 | 68 | 24 | 8 |
| None | 21 | 0 | none | | 75 | 20 | 25 | 68 | 24 | 8 |
| None | 21 | 0 | none | | 50 | 20 | 50 | 68 | 24 | 8 |
| None | 21 | 0 | none | | 25 | 20 | 75 | 68 | 24 | 8 |
| None | 21 | 0 | A-40 | 1000 | 90 | 20 | 10 | 68 | 24 | 8 |
| | | | | ppm | | | | | | |
| None | 21 | 0 | A-40 | 1000 | 75 | 20 | 25 | 68 | 24 | 8 |
| | | | | ppm | | | | | | |
| None | 21 | 0 | A-40 | 1000 | 50 | 20 | 50 | 68 | 24 | 8 |
| | | | | ppm | | | | | | |
| None | 21 | 0 | A-40 | 1000 | 25 | 20 | 75 | 68 | 24 | 8 |
| | | | | ppm | | | | | | |
| None | 8 | 0 | A-40 | 2000 | 90 | 20 | 10 | 68 | 24 | 8 |
| | | | | ppm | | | | | | |
| None | 8 | 0 | A-40 | 2000 | 75 | 20 | 25 | 68 | 24 | 8 |
| | | | | ppm | | | | | | |
| None | 8 | 0 | A-40 | 2000 | 50 | 20 | 50 | 68 | 24 | 8 |
| | | | | ppm | | | | | | |
| None | 8 | 0 | A-40 | 2000 | 25 | 20 | 75 | 68 | 24 | 8 |
| | | | | ppm | | | | | | |
| None | 16 | 0 | A-40 | 2000 | 90 | 20 | 10 | 68 | 24 | 8 |
| | | | | ppm | | | | | | |
| None | 16 | 0 | A-40 | 2000 | 75 | 20 | 25 | 68 | 24 | 8 |
| | | | | ppm | | | | | | |
| None | 16 | 0 | A-40 | 2000 | 50 | 20 | 50 | 68 | 24 | 8 |
| | | | | ppm | | | | | | |
| None | 16 | 0 | A-40 | 2000 | 25 | 20 | 75 | 68 | 24 | 8 |
| | | | | ppm | | | | | | |
| STAGE 5 | Stage 1 - Best of Stage 2, 3, or 4 with floc USED DILUTED POLYMER (0.1%) FOR THIS SET OF TESTS | | | | | | | | | |
| B | 8 | 100 | none | | 90 | | 10 | 68 | 24 | 8 |
| B | 8 | 100 | none | | 75 | | 25 | 68 | 24 | 8 |
| B | 8 | 100 | none | | 50 | | 50 | 68 | 24 | 8 |
| B | 8 | 100 | none | | 25 | | 75 | 68 | 24 | 8 |
| B | 8 | 100 | A-40 | 2000 | 90 | 25 | 10 | 68 | 24 | 8 |
| | | | | ppm | | | | | | |
| B | 8 | 100 | A-40 | 2000 | 75 | 25 | 25 | 68 | 24 | 8 |
| | | | | ppm | | | | | | |
| B | 8 | 100 | A-40 | 2000 | 50 | 25 | 50 | 68 | 24 | 8 |
| | | | | ppm | | | | | | |
| B | 8 | 200 | A-40 | 2000 | 63 | 30 | 7 | 68 | 24 | 8 |
| | | | | ppm | | | | | | |
| B | 8 | 200 | A-40 | 2000 | 52.5 | 30 | 17.5 | 68 | 24 | 8 |
| | | | | ppm | | | | | | |
| B | 8 | 200 | A-40 | 2000 | 35 | 30 | 35 | 68 | 24 | 8 |
| | | | | ppm | | | | | | |
| B | 16 | 200 | A-40 | 2000 | 63 | 30 | 7 | 68 | 24 | 8 |
| | | | | ppm | | | | | | |
| B | 16 | 200 | A-40 | 2000 | 52.5 | 30 | 17.5 | 68 | 24 | 8 |
| | | | | ppm | | | | | | |
| B | 16 | 200 | A-40 | 2000 | 35 | 30 | 35 | 68 | 24 | 8 |
| | | | | ppm | | | | | | |
| B | 16 | 200 | A-40 | 2000 | 63 | 30 | 7 | 68 | 24 | 8 |
| | | | | ppm | | | | | | |
| B | 16 | 200 | A-40 | 2000 | 52.5 | 30 | 17.5 | 68 | 24 | 8 |
| | | | | ppm | | | | | | |
| B | 16 | 200 | A-40 | 2000 | 35 | 30 | 35 | 68 | 24 | 8 |
| | | | | ppm | | | | | | |
| B | 8 | 200 | none | | 90 | 0 | 10 | 68 | 24 | 8 |
| B | 8 | 200 | none | | 75 | 0 | 25 | 68 | 24 | 8 |
| B | 8 | 200 | none | | 50 | 0 | 50 | 68 | 24 | 8 |
| B | 8 | 200 | none | | 25 | 0 | 75 | 68 | 24 | 8 |
| B | 8 | 200 | A-40 | 2000 | 90 | 0 | 10 | 68 | 24 | 8 |
| | | | | ppm | | | | | | |
| B | 8 | 200 | A-40 | 2000 | 75 | 0 | 25 | 68 | 24 | 8 |
| | | | | ppm | | | | | | |
| B | 8 | 200 | A-40 | 2000 | 50 | 0 | 50 | 68 | 24 | 8 |
| | | | | ppm | | | | | | |
| B | 8 | 200 | A-40 | 2000 | 25 | 0 | 75 | 68 | 24 | 8 |
| | | | | ppm | | | | | | |

| | Results | | | | | |
|---|---|---|---|---|---|---|
| Cat. | % | % | % | % | % | |
| Floc.(I) | oil | BSW | water | solids | rag | Comments |

| 18-Jun- 04 | | | | | | |
|---|---|---|---|---|---|---|
| STAGE 1 | Blanks No Chemicals | | | | | |
| None | 70 | 30 | 0 | | | |
| None | 50 | 50 | 0 | | | |
| None | 80 | 20 | 0 | | Entire sameple is closer | |
| | | | | | to 11 mL after spinning | |
| None | 10 | 90 | 0 | | Entire sameple is closer | |
| | | | | | to 11 mL after spinning | |
| STAGE 2 | Demulsifier at 1000 ppm | | | | | |
| None | 70 | 30 | 0 | | | |
| None | 50 | 50 | 0 | | | |
| None | 75 | 25 | 0 | | Entire sameple is closer | |
| | | | | | to 11 mL after spinning | |
| None | 10 | 90 | 0 | | Entire sameple is closer | |
| | | | | | to 11 mL after spinning | |
| STAGE 3 | Demulsifier at 2000 ppm | | | | | |
| None | 67 | 33 | 0 | | remaining BS&W is drill | |
| | | | | | mud | |
| None | 50 | 50 | 0 | | remaining BS&W is drill | |
| | | | | | mud | |
| None | 79 | 21 | 0 | 10 | Entire sample is closer | remaining BS&W |
| | | | | | to 11 mL after spinning | is drill mud |
| None | 10 | 90 | 0 | 15 | Entire sample is closer | remaining BS&W |
| | | | | | to 11 mL after spinning | is drill mud |

| STAGE 4 | Stage 1 - Best of either Stage 2 or 3 with 20% water | | | | | |
|---|---|---|---|---|---|---|
| None | 55 | 45 | | | | No visible water |
| None | 35 | 65 | | | | No visible water |
| None | 22 | 78 | | | | No visible water |
| None | 5 | 95 | | | | No visible water |
| None | 50 | 50 | | | | No visible water |
| None | 30 | 70 | | | | No visible water |
| None | 24 | 76 | | | | No visible water |
| None | 5 | 95 | | | | No visible water |
| None | 55 | 45 | 10 | | 35 | “heavy rag” |
| None | 50 | 50 | | | | No visible water |
| None | 35 | 65 | | | | No visible water |
| None | 10 | 90 | | | | |
| None | 60 | 40 | 10 | | 30 | “heavy rag” |
| None | 45 | 55 | | | | No visible water |
| None | 35 | 65 | | | | No visible water |
| None | 10 | 90 | | | | |
| None | 50 | 50 | | | | No visible water |
| None | 30 | 70 | | | | No visible water |
| None | 10 | 90 | | | | No visible water |
| None | 10 | 90 | | | | No visible water |
| None | 50 | 50 | | | | |
| None | 45 | 55 | | | | No visible water |
| None | 30 | 70 | | | | No visible water |
| None | 10 | 30 | | | | No visible water |
| STAGE 5 | Stage 1 - Best of Stage 2, 3, or 4 with floc USED DILUTED | | | | | |
| | POLYMER (0.1%) FOR THIS SET OF TESTS | | | | | |
| B | — | — | — | — | — | Sample not run |
| B | — | — | — | — | — | Sample not run |
| B | — | — | — | — | — | Sample not run |
| B | — | — | — | — | — | Sample not run |
| B | 44 | 56 | | | | no visible water |
| B | 35 | 65 | | | | no visible water |
| B | 17 | 83 | | | | no visible water |
| B | 25 | 60 | 15 | | | clear water |
| B | 30 | 70 | | | | no visible water |
| B | 20 | 80 | | | | no visible water |
| B | 50 | 50 | 22 | 28 | | clear water |
| B | 42 | 58 | | | | no visible water |
| B | 30 | 70 | | | | no visible water |
| B | 50 | 50 | 27 | 23 | | clear water |
| B | 37 | 63 | | | | no visible water |
| B | 30 | 70 | | | | |
| B | | | | | | no visible water |
| B | | | | | | no visible water |
| B | | | | | | no visible water |
| B | | | | | | no visible water |
| B | 62 | 38 | | | | no mud separation |
| B | 55 | 45 | | | | no mud separation |
| B | 30 | 70 | | | | no mud separation |
| B | 15 | 85 | | | | |

A-40 is a 39 wt % non volatile solids content tannin/AETAC copolymer in water wherein the molar ration of tannin: AETAC is 1:4.89 (cationic coagulant (II)). B is a water in oil emulsion having a nominal wt % nonvolatile solids content of 49%; the oil is a mixture of hydrotreated isoparaffins and napthenics with a very low level of aromatics; the water phase includes acrylamide (AA)/AETAC copolymer in a molar ratio of about 60/40 (cationic flocculant (I)).

As per the above, the combined treatment in accordance with the invention can be used, inter alia, to separate a crude oil/drilling mud emulsion of the type discussed above wherein the drilling mud may seep out of its down hole location into the crude oil produced by the well. Additionally, the combined treatment may be used to resolve inverted (W/O) emulsions of the type recovered from the down hole drilling muds as they are commonly referred to in the art as slop or slop oils.

While the compositions and methods of the present invention have been described above in terms of illustrative embodiments, it will be appreciated by those of skill in the art that variations may be applied to the process described herein without departing from the concept and scope of the invention. All such similar substitutes and modifications apparent to those skilled in the art are deemed to be within the scope and concept of the invention as set forth in the following claims.

What is claimed is:

1. A method of separating a drilling mud emulsion comprising an oleaginous component, a non-oleaginous component, and clay dispersed therein comprising adding an emulsion breaker composition to said drilling mud emulsion, said emulsion breaker composition comprising (I) a cationic acrylamide/quaternary ammonium copolymer (AA/QAC) and (II) a cationic copolymer of a tannin and a cationic monomer (T/CM) said method further comprising mixing said composition and said emulsion.

2. Method as recited in claim 1 wherein said oleaginous component comprises crude oil.

3. A method as recited in claim 2 further comprising separating said emulsion into an oleaginous phase and a second phase comprising clay, and a third phase comprising water.

4. Method as recited in claim 3 further comprising adding about 1-2,000 ppm, of said AA/QAC (I) and about 100-3,000 ppm of said T/CM (II) to said emulsion, based on one million parts of said emulsion.

5. Method as recited in claim 4 wherein about 25-150 ppm of said AA/QAC and about 250-1,000 ppm of said T/CM are added to said emulsion.

6. Method as recited in claim 5 wherein said step of separating is performed in a centrifugal separator.

7. Method as recited in claim 1 wherein said emulsion is an inverted slop oil drilling mud emulsion.

8. Method as recited in claim 1 wherein said AA/QAC(I) has the structure 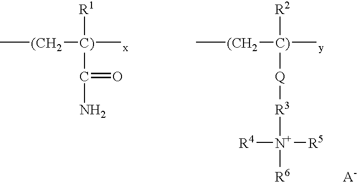
wherein the ratio of repeat units x:y may vary from 95:5 to 5:95; R¹ and R² may be the same or different and are chosen from H and CH₃; Q is —C(O)O—, —OC(O)—, or —C(O)NH—, R³ is branched or linear (C₁-C₄) alkylene, R⁴, R⁵, and R⁶ are independently chosen from H, C₁-C₄ linear branched alkyl, or an C₅-C₈ aromatic or alkylaromatic group, A is an anion selected from Cl⁻, Br⁻, HSO₄, or MeOSO₃⁻.

9. Method as recited in claim 8 wherein said repeat unit y is chosen from AETAC—2-acryloxyethyltrimethyl ammonium chloride; MAPTAC—3-(meth)acrylamidopropyltrimethyl ammonium chloride and METAC—2-methacryloxyethyltrimethyl ammonium chloride.

10. Method as recited in claim 8 wherein the weight percent of said tannin in said T/CM(II) is from about 10-80 wt % of said copolymer (II).

11. Method as recited in claim 10 wherein said CM in said T/CM(II) is a cationic monomer selected form the group consisting of methyl chloride or dimethyl sulfate quaternary salt of dimethylaminoethyl acrylate, diethylaminopropyl methacrylamide, and dimethylaminopropyl acrylamide.

12. Method as recited in claim 11 wherein said CM is methyl chloride quaternary salt of dimethylaminoethyl acrylate.
